(19) United States
(12) Patent Application Publication
(10) Pub. No.: US 2011/0031233 A1
(43) Pub. Date: Feb. 10, 2011

(54) Food Heater

(76) Inventor: Laura Pandelle, Paris (FR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/680,287

(22) PCT Filed: Aug. 21, 2008
(86) PCT No.: PCT/EP2008/006865

§ 371 Date: Oct. 27, 2010

(30) Foreign Application Priority Data
Sep. 26, 2007 (SE) 0702147-0

(51) Int. Cl. H05B 3/02

(52) U.S. Cl. 219/442

(57) ABSTRACT

A food heater having a base arranged to receive food, a heating system in the base, and a cover configured to form, with the base, a closed chamber in which food may be positioned during food preparation. A photovoltaic system is in the cover. The photovoltaic system has one or more solar cells adapted to absorb solar energy and store the solar energy in one or more batteries. The heating system is adapted to receive the solar energy when the cover is connected to the base, to thereby facilitate food preparation in the food heater.

### FIELD OF THE INVENTION

The present invention relates to a food heater or cooker for cooking and food preparation. In particular, the present invention relates to a food heater based on solar energy.

### BACKGROUND OF THE INVENTION

Powerful kitchen appliances conceived to bake, such as ovens, microwaves and hot plates, are frequently used for short time periods according to modern food habits. In particular, these electric appliances, such as microwaves, are used to reheat or defrost food. A drawback of such appliances is that they waste a lot of energy.

As an alternative, solar ovens based on solar energy enable the reduction of the energy waste. However, the cooking is often time-consuming and rather constraining.

A further drawback of existing solar and microwave ovens is that it is difficult to obtain intermediate levels of temperature, which limits the quality and precision of cooking.

Thus, there is a need for providing improved cookers or food heaters which would overcome some of these problems.

### SUMMARY OF THE INVENTION

An object of the present invention is to wholly or partly overcome the above disadvantages and drawbacks of the prior art and to provide improved cookers or food heaters.

The present invention provides a food heater or cooker which enables reduction of the waste of energy when cooking.

Hence, according to a first aspect of the present invention, a food heater is provided. The food heater includes a base arranged to receive food and comprising a heating system. The food heater includes also a cover or cap arranged to form with the base a closed chamber in which food is positioned during food preparation. The cover or cap comprises a photovoltaic system adapted to absorb and load solar energy. The heating system is powered by the loaded energy received from the cover when the cover is connected to the base during food preparation.

The present invention is based on an insight that a photovoltaic system may be incorporated in a container or recipient to absorb and load solar energy for cooking or heating.

Although the photovoltaic system is preferably arranged in the cover, the photovoltaic system may also be arranged in the base of the food heater.

The food heater according to the present invention is advantageous as it enables cooking with solar energy, thereby reducing energy waste. The energy loaded in the cover is transferred to the base, which, in turn, warms up the food placed inside the closed chamber by means of the heating system.

The present invention is particularly advantageous for short cooking periods, which, with conventional ovens, waste a lot of energy. The inventive food heater reduces significantly the waste of energy since it is based on solar energy.

The present invention is also advantageous in that an ecological food heater is provided.

Another advantage of the present invention is that cooking becomes cheap since solar energy is used.

According to an embodiment, the base of the food heater is arranged to receive a food container to be positioned within the closed chamber and in thermal contact with the base, which is advantageous since the use of a food container protects the interior surface of the base. The use of an intermediate food container is also advantageous as the size of the food container may be chosen in function of the amount of food to be cooked or prepared, thereby optimizing the heating process.

According to an embodiment, the heating system comprises an induction heating device, which is advantageous since quasi instantaneous heating may be obtained. The food heater is therefore fast, thereby enabling fast cooking suitable to modern cooking habits.

According to an embodiment, the food container is made of steel, which is suitable for cooking by induction.

According to an embodiment, the cover comprises a solar absorbent coating surface. In particular, the photovoltaic system may be made of spray-on solar cells which are nanoparticles of silicium sprayed on the surface of the cover.

According to an embodiment, the base has the form of a container in which food is positioned. In particular, the base and the cover form a hermetical container, thereby limiting loss of heat during food preparation.

According to an embodiment, the food container has a shape matching the shape of the base.

According to an embodiment, the base has a flat bottom forming a hot plate on which food or a food container may be placed. In particular, the hot plate is covered with a vitroceramic coating, which is suitable for a heating system comprising an induction device. Further, a vitroceramic surface has the advantage to spread heat quickly and to be easy to clean without any chemical products, thereby rendering the food heater user-friendly and ecological.

According to an embodiment, the food heater may comprise at least one temperature sensor arranged to detect the temperature in at least one of the cover, the base and the food container, which is advantageous since this provides a food heater with very precise control of the temperature and thereby the baking degree of a preparation.

According to an embodiment, at least one of the cover and the base comprises an indicator indicating if the energy stored in the photovoltaic system is above a predefined value. Alternatively, the indicator may comprise more than one predefined values. A predefined value may correspond to a value above which a particular type or mode of cooking is not possible, e.g. if the energy loaded in the cover or cap is not sufficient. The indicator is preferably, but not necessarily, arranged at the base.

According to an embodiment, at least one of the cover and base comprises a keypad or keyboard to select a cooking program or mode.

According to an embodiment, the cover has at least one ear arranged to grip the food heater, which is advantageous as the food heater may become hot. The ears of the heater are preferably made of plastic material.

According to an embodiment, the base forms a cavity, which is advantageous if the food heater is not used with a food container. A cavity enables the formation of the closed chamber in which food may be placed.

According to an embodiment, the opening of the cavity of the base or the food container is ellipsoidal and comprises edges on which the cover rest during food preparation. In particular, the edges of the base are further arranged to receive the food container.

According to an embodiment, the photovoltaic system comprises a semi stationary battery which enables the loading of energy.

The present invention is advantageous since it combines a sustainable cookware and a high quality and precision in cooking.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

The above, as well as additional objectives, features and advantages of the present invention, will be better understood through the following detailed description and illustrative drawings, in which:

FIG. 1 shows a food heater according to an embodiment of the present invention; and

FIG. 2 shows an exploded view of a food heater according to an embodiment of the present invention.

FIG. 3 illustrates the use of the cover of a food heater according to an embodiment of the present invention;

FIG. 4 illustrates a scenario for use of a food heater according to an embodiment of the present invention;

FIG. 5 illustrates a base of a food heater according to an embodiment of the present invention;

FIG. 6 illustrates a display of a food heater according to an embodiment of the present invention;

FIG. 7 shows examples of food containers according to embodiments of the present invention; and

FIG. 8 shows an exploded view of a food heater according to an embodiment of the present invention.

### DETAILED DESCRIPTION OF THE INVENTION

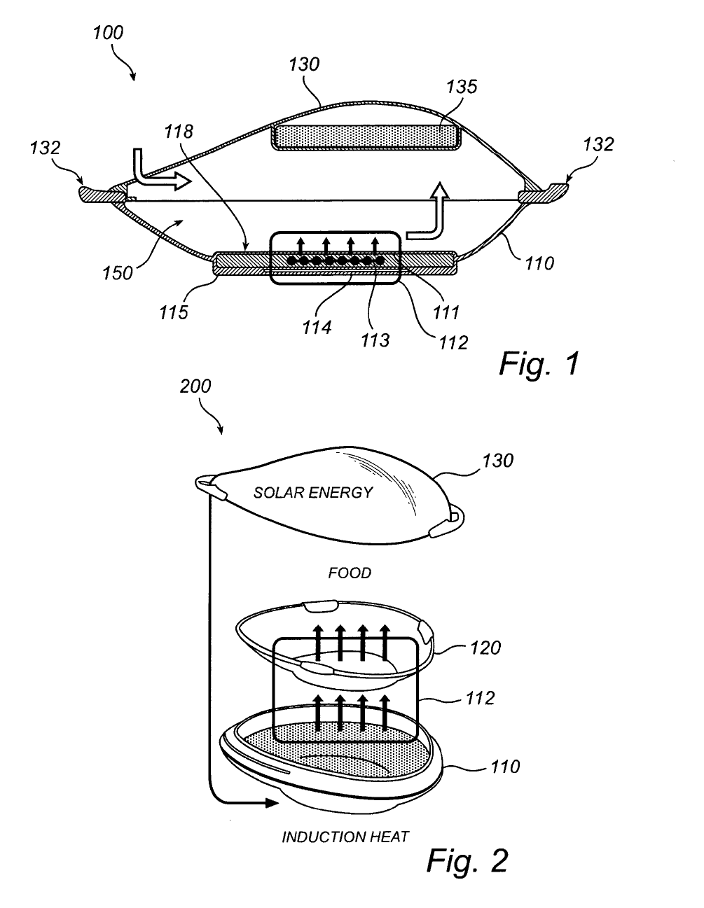

With reference to FIG. 1, a first embodiment of the present invention will be described.

FIG. 1 shows a food heater 100 including a base 110 and a cover or cap 130. The base 110 and the cover 130 are mounted together to form a closed chamber 150 within which food or a food preparation may be placed during food preparation. The empty volume corresponding to the interior of the base 110 is represented in white while the empty volume corresponding to the interior of the cover 130 is represented in black (dark). The cover 130 comprises a photovoltaic system 135 adapted to absorb and to load solar energy. The base 110 comprises a heating system 115 which is powered by the loaded energy received from the cover 130 when the cover 130 is connected to the base 110 during food preparation.

The heating system 135 is adapted to heat up the food placed in the closed chamber 150. The heating system 135 may be a resistance which, when powered by the energy loaded in the cover 130, heats a region of the base 110 and thereby the food placed on it. Electronics or an electronic circuit 114 is arranged at the base 110 to receive the energy from the photovoltaic system 135 and power the heating system 115. Alternatively, the electronics or electronic module 114 is a part of the heating system 115.

According to an embodiment, the base of the food heater is arranged to receive a food container 120. In this case, the heating system is adapted to heat up the food placed in the food container 120.

FIG. 2 is an exploded view of a food heater 200 which illustrates where the food container 120 is arranged, namely in the closed chamber 150 between the cover 130 and the base 110. The cover 130 is arranged to receive solar energy and, when connected to the base 110, transfer this energy to the heating system 115 of the base 110, e.g. via the electronics 114.

According to an embodiment, such as illustrated in FIGS. 1 and 2, the heating system comprises an induction heating device 113, which, in operation, generates an electromagnetic field represented by the reference number 112 in FIG. 1 and FIG. 2. Induction technology heats up food by creating an electromagnetic field between the induction heating device or coil 113 and the metallic food container 120 placed in contact with it. As soon as the container 120 is removed from the base 110, the heat stops, like a natural switch. Consequently, there is no or very little loss of energy since the time to heat and cool down is very short, and a high precision cooking is achieved.

Although the photovoltaic system 135 is represented by a block in FIG. 1, it is to be understood that the whole cover or a part of the cover 130 may be designed for absorbing energy. The block shown in FIG. 1 may for instance correspond to a battery in which the absorbed solar energy is stored or loaded. In particular, the battery may be a semi-stationary battery which is adapted to accumulate energy during the day, e.g. corresponding to powers ranging from 50 to 200 Watts.

According to an embodiment, the cover 130 comprises a solar absorbent coating surface. In particular, the surface of the cover 130 is sprayed by nanoparticles of silicium (so called DSSC solar cells), which spraying converts the surface in efficient photovoltaic panels. The DSSC cells are sensitive to both visible and non-visible radiation (infrared radiation), which means that they can produce energy even on a cloudy day.

Further, the base 110 may comprise temperature sensors 111 enabling the control of the temperature in the food heater 100.

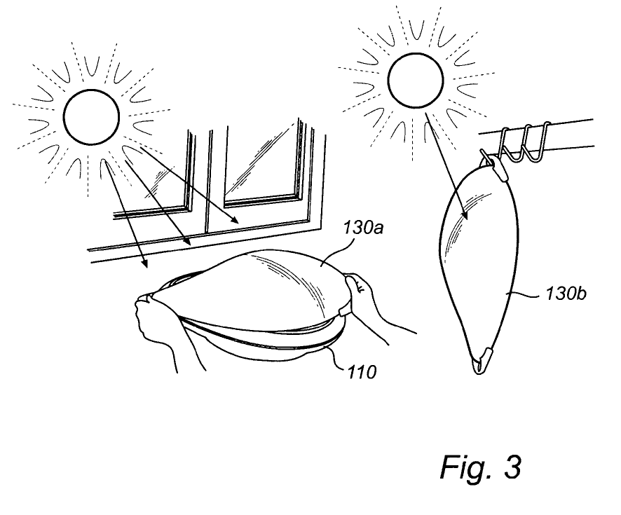

FIG. 3 illustrates how the cover may be exposed to sunlight or other radiations to absorb and load energy. In a first alternative, the cover 130a of the food heater is exposed to sunlight through a window. In a second alternative, the cover 130b of the food heater is suspended or attached in a kitchen and thereby permanently exposed to sunlight in order to accumulate a maximum of energy. The cover may rest in a place exposed to sun during the day, such as behind a window of a kitchen, and used in the evening for cooking.

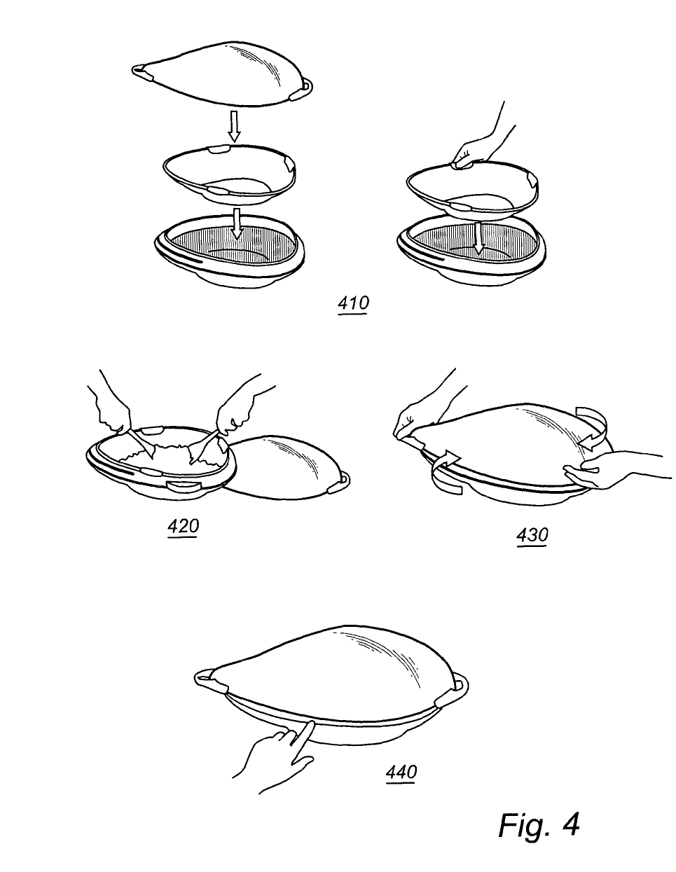

With reference to FIG. 4, a scenario, in which the food heater according to the present invention is used, will be described.

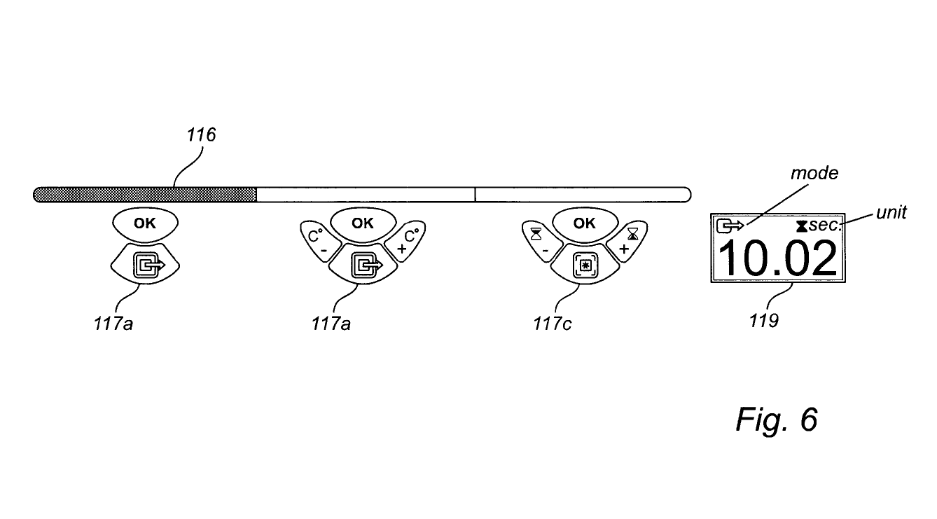

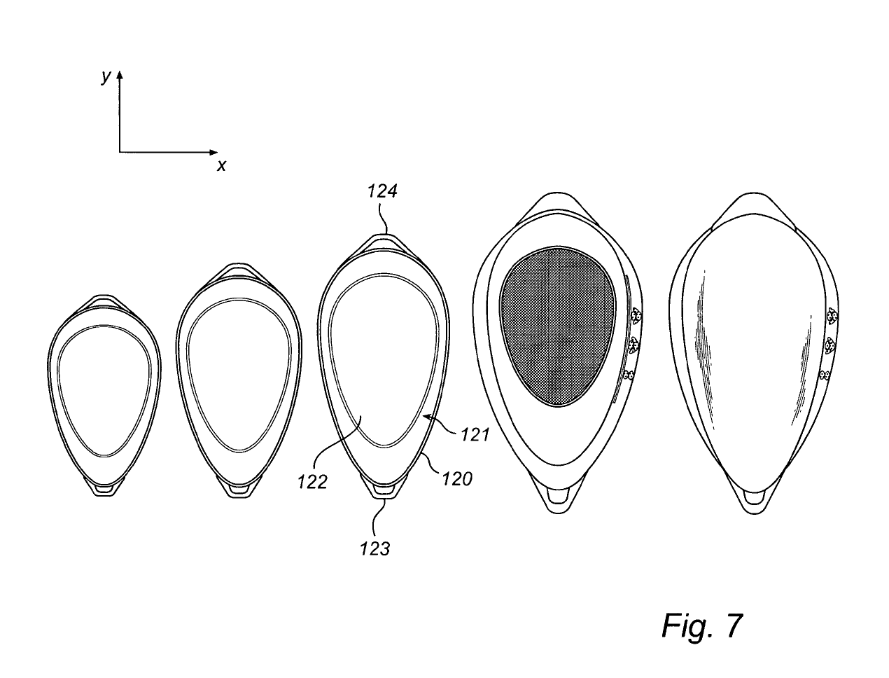

In a first step 410, an user of the food heater 100 selects one of the adapted containers among a plurality of or set of steel nesting containers, such as those depicted with reference to FIG. 7. The size of the selected container may be selected depending on the quantity of food to heat or on the level of cooking to be obtained since the container's shape and size directly affect the heating of the food preparation. The size of the flat bottom of the food container may for instance vary, thereby decreasing or increasing the size of the hottest regions of the food container. In a second step 420, the user places his/her preparation or hot ingredients in the food container 120. In a third step 430, the user places the cover 130 on top of the base 110 and the food container 120, thereby forming a hermetical container or closed chamber 150. As soon as the cover 130 is in contact with the base 110, an indicator 116, e.g. in the form of a light line, indicates the level of energy stored in the cover 130. Thus, in a fourth step 440, the user checks whether the level of energy is sufficient. If the level of energy is not sufficient, the user may then choose to expose the cover to sunlight in a similar manner as in the examples described with reference to FIG. 3. If the level of energy is sufficient, the user may select a heating mode. Different types of heating mode will be described in the following with reference to FIG. 6.

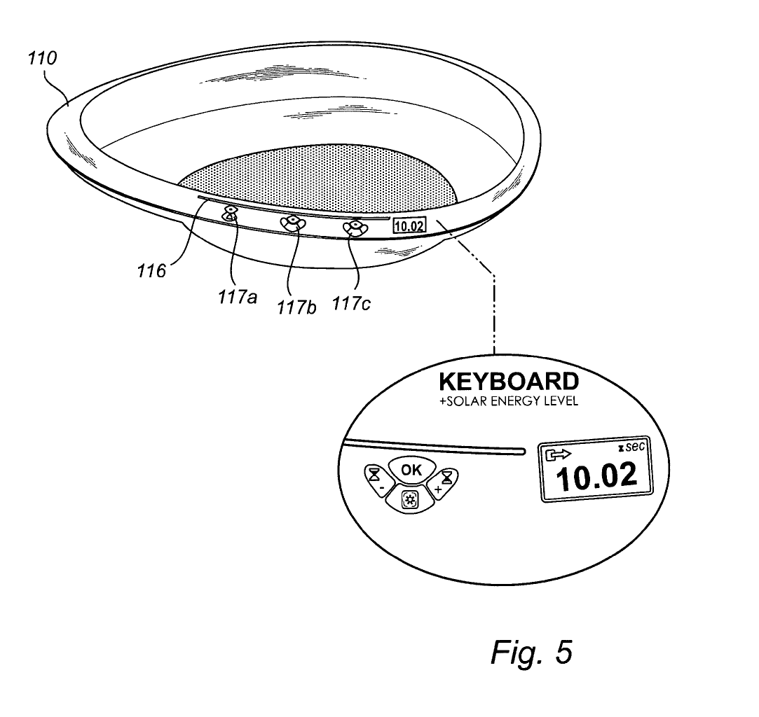

FIG. 5 shows a base of a food heater according to an embodiment of the present invention. The base comprises an indicator 116 arranged at an edge of the base 110. Depending on the level of energy stored in the cover 130 and indicated by the indicator 116, one of three different modes of cooking 117a, 117b and 117c may be available to the user. The indicator 116 comprises three regions delimited by two predetermined values, which regions correspond to the three modes of cooking.

With reference to FIG. 6, three programs or modes of cooking are defined by predefined values of energy level. In a first mode 117a, the food heater is set to keep an ingredient hot. This first mode 117a is suitable for recipes in which the temperature of the food has to be precisely controlled. In the present mode 117a, the food heater may be used to keep ingredient at a constant temperature without the need of heating up the ingredient at the last moment, such as with conventional food heaters. This first mode 117a operates like an automatic standby mode in which the food heater memorizes the temperature of the preparation via a thermometer or temperature sensor 111 and autoregulates the heating system.

In a second mode 117b, which requires a higher level of energy than the first mode 117a, thus only available to the user if sufficient energy is loaded in the photovoltaic system of the cover, the food heater is set to heat up a small quantity of food. The food heater may first measure the temperature of the food via a temperature sensor 111 and display the measured temperature on the display 119. The user may then enter a desired temperature by means of the keys of the keypad or keyboard corresponding to the second mode 117b.

In a third mode 117c, which requires a higher energy level than the first and second modes 117a and 117b, the food heater may be set to defrost, melt, dry or evaporate an ingredient. Thus, in this mode 117c the food heater has loaded enough energy in the photovoltaic system of the cover 130 to transform a food's state.

The heating time may be controlled with the lateral buttons, which is displayed on the display 119. The present mode 117c is suitable for small quantities or delicate ingredients which require a particular attention.

With reference to FIG. 7, a set of food containers 120 is described. The food containers 120 may have an ellipsoidal or oval opening 121 and a flat bottom 122 matching the bottom of the base 110. The food container 120 may also comprise an ear 123 enabling to grip and to lift the container from the food heater. The ear may preferably be made of polymer or hard plastic materials. Further, the food container may comprise an edge 124 arranged to rest on a corresponding edge of the base 110 of the food heater 100. Examples of sizes for the food containers shown in FIG. 7 ranges from 250 to 390 mm in length (from the ear 123 to the edge 124), i.e. along the y-axis represented in FIG. 7, and from 55 to 280 mm in width, i.e. along the x-axis represented in FIG. 7.

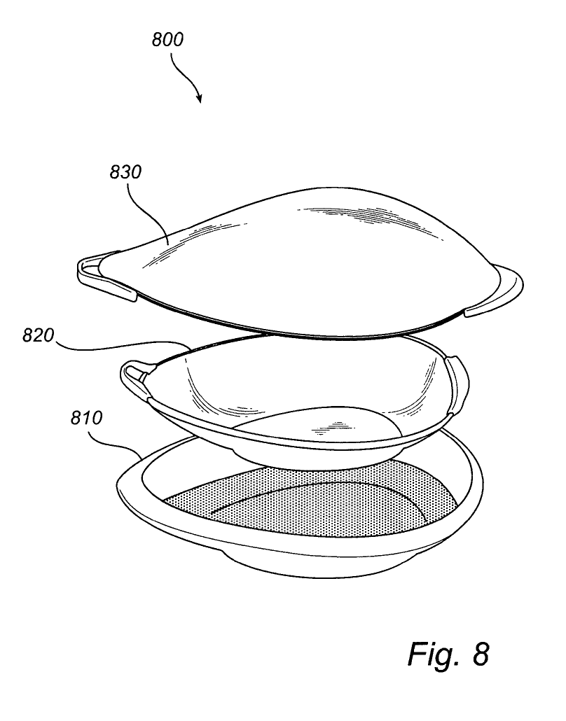

FIG. 8 shows an exploded view of a food heater according to an embodiment of the present invention. The food heater 800 comprises a cover 830 equivalent to the cover described with reference to FIG. 1-3, a base 110 equivalent to the base described with reference to FIG. 1-3. The base and the cover are arranged to receive a food container 820 equivalent to the food containers described with reference to FIG. 7. The base 810 comprises an indicator, a display and keypads for three modes of cooking, which indicator, display and modes are equivalent to that described with reference to FIGS. 5 and 6.

Although the invention above has been described in connection with preferred embodiments of the invention, it will be evident for a person skilled in the art that several modifications are conceivable without departing from the scope of the invention as defined by the following claims.

1. A food heater comprising:
a base arranged to receive food;
a heating system in the base;
a cover configured to form, with the base, a closed chamber in which food may be positioned during food preparation;
a photovoltaic system in the cover, the photovoltaic system comprising one or more solar cells adapted to absorb solar energy and store the solar energy in one or more batteries;
wherein the heating system is adapted to receive the solar energy when the cover is connected to the base, to thereby facilitate food preparation in the food heater.

2. The food heater as defined in claim 1, wherein the base is arranged to receive a food container adapted to be positioned within the closed chamber and in thermal contact with the base.

3. The food heater as defined in claim 2, wherein the heating system comprises an induction heating device.

4. The food heater as defined in claim 2, wherein the food container is made of steel.

5. The food heater as defined in claim 3, wherein the food container is made of steel.

6. The food heater as defined in anyone of the preceding claims, wherein the cover comprises a solar absorbent coating surface.

7. The food heater as defined in claim 1, wherein the photovoltaic system is comprises spray-on solar cells comprising nanoparticles of silicium sprayed on the surface of the cover.

8. The food heater as defined in claim 1, wherein the base has the form of a container.

9. The food heater as defined in claim 8, wherein the base and the cover are connectable to form a hermetical container.

10. The food heater as defined in claim 2, wherein the food container has a shape matching the shape of the base.

11. The food heater as defined in claim 1, wherein the base has a flat bottom forming a hot plate on which food or a food container can be placed.

12. The food heater as defined in claim 11, wherein the hot plate is covered with a vitroceramic coating.

13. The food heater as defined in claim 1, further comprising at least one temperature sensor to detect the temperature in at least one of the cover or the base.

14. The food heater as defined in claim 2, further comprising at least one temperature sensor to detect the temperature in at least one of the cover, the base, or the food container.

15. The food heater as defined in claim 1, wherein at least one of the cover and the base comprises an indicator adapted to indicate whether the solar energy stored in the photovoltaic system is above a predefined value.

16. The food heater as defined in claim 1, wherein at least one of the cover and the base comprises a keypad to select a cooking program or cooking mode.

17. The food heater as defined in claim 1, wherein the cover has at least one ear to grip the food heater.

18. The food heater as defined in claim 1, wherein the base form a cavity having an ellipsoidal opening having edges on which the cover rests during food preparation.

19. The food heater as defined in claim 18, wherein the edges are further arranged to receive a food container.

20. The food heater as defined in claim 1, wherein the photovoltaic system comprises a semi-stationary battery.
